(19) United States
(12) Patent Application Publication
(10) Pub. No.: US 2024/0116106 A1
(43) Pub. Date: Apr. 11, 2024

(54) METHOD FOR IMPROVING COERCIVITY OF NEODYMIUM-IRON-BORON MAGNET AND MAGNET PREPARED BY METHOD

(71) Applicant: Yantai Dongxing Magnetic Materials Inc., Yantai (CN)

(72) Inventors: Kunkun YANG, Yantai (CN); Zhongjie PENG, Yantai (CN); Chuanshen WANG, Yantai (CN); Kaihong DING, Yantai (CN)

(21) Appl. No.: 18/378,130

(22) Filed: Oct. 9, 2023

(30) Foreign Application Priority Data
Oct. 10, 2022 (CN) 202211239979.9

(51) Int. Cl. B22F 3/24; H01F 1/057; H01F 41/02

(52) U.S. Cl. CPC B22F 3/24; H01F 1/0577; H01F 41/0293; B22F 2003/242; B22F 2003/248

(57) ABSTRACT

The present disclosure relates to the technical field of neodymium-iron-boron preparation, in particular to a method for improving the coercivity of a neodymium-iron-boron magnet and a magnet prepared by the method. The method specifically includes: (S1) subjecting a heavy rare earth diffusion source powder, an organic adhesive, a spherical high temperature resistant ceramic powder and an organic solvent to mixing and stirring to prepare a heavy rare earth slurry; (S2) coating a surface of a neodymium-iron-boron magnet with the heavy rare earth slurry and drying the heavy rare earth slurry to form a heavy rare earth coating; and (S3) performing high-temperature diffusion and aging treatment. According to the method above, the heavy rare earth coating has high hardness and strength. In addition, the neodymium-iron-boron magnet has higher and more uniform properties after diffusion, and less heavy rare earth elements are consumed.

### TECHNICAL FIELD

The present disclosure relates to the field of production of neodymium-iron-boron magnets, in particular to a method for improving the coercivity of a neodymium-iron-boron magnet and a magnet prepared by the method.

### BACKGROUND

Sintered neodymium-iron-boron permanent magnets have been widely used in air conditioners, automobiles, medical treatment, industries and other fields. With the development of the times, on the one hand, the sintered neodymium-iron-boron permanent magnets are required to have higher miniaturization and lamination levels; and on the other hand, the sintered neodymium-iron-boron permanent magnets are required to have higher remanence and coercivity.

The coercivity of the sintered neodymium-iron-boron permanent magnets can be improved by adding terbium and dysprosium into alloys of the sintered neodymium-iron-boron permanent magnets. However, the terbium and the dysprosium will be added into main phase grains by a traditional composition blending method, thereby significantly reducing the remanence of the permanent magnets and consuming large amounts of heavy rare earth elements.

A Chinese patent with a publication No. CN107578912A disclosed a method for preparing a neodymium-iron-boron magnet having high coercivity. The method included mixing a heavy rare earth powder with an antioxidant, an adhesive and an organic solvent to obtain a suspension, coating a surface of a neodymium-iron-boron magnet with the suspension, and drying the suspension, followed high-temperature diffusion and aging treatment to improve the coercivity of the magnet. The method has high production efficiency and a high material utilization rate, thus having been widely used. However, due to low hardness and strength, a heavy rare earth coating prepared by the method is easily scratched or worn, leading to loss of heavy rare earth elements in a local area, so that a diffusion effect is affected. In addition, such film coating is prone to irregular shrinkage in diffusion and heating processes, leading to loss of the heavy rare earth elements in a local area of the surface of the neodymium-iron-boron magnet and excessive accumulation of the heavy rare earth elements in some areas, so that the neodymium-iron-boron magnet has poor uniformity of properties after the diffusion.

During the high-temperature diffusion of the coating on the surface of the neodymium-iron-boron magnet, the heavy rare earth elements are oversupplied in a short term, so that excessive amounts of the heavy rare earth elements are consumed by excessive reactions of the surface of the neodymium-iron-boron magnet with the heavy rare earth elements. Meanwhile, due to insufficient supply, the heavy rare earth elements in the neodymium-iron-boron magnet are poorly dispersed, so that the surface and the center of the magnet eventually have large differences in properties after the diffusion, and excessive amounts of the rare earth elements are consumed.

### SUMMARY

Purposes of the present disclosure: In order to solve the problems that heavy rare earth coatings have low hardness and strength, are easily scratched and worn in a production process and are prone to shrinkage in a diffusion process and heavy rare earth elements have poor diffusion uniformity and high consumption due to excessive supply of the heavy rare earth elements in a short term in the prior art, the present disclosure provides a method for improving the coercivity of a neodymium-iron-boron magnet and a magnet prepared by the method.

Technical schemes: In order to achieve the above purposes, a method for improving the coercivity of a neodymium-iron-boron magnet of the present disclosure includes the following steps:
(S1) subjecting a heavy rare earth diffusion source powder, an organic adhesive, a spherical high temperature resistant ceramic powder and an organic solvent to mixing and stirring to prepare a heavy rare earth slurry, wherein the particle size of the spherical high temperature resistant ceramic powder is required to be 5-10 times of that of the diffusion source powder, and the weight of the spherical high temperature resistant ceramic powder is 10%-30% of that of the heavy rare earth diffusion source powder;
(S2) coating a surface of a neodymium-iron-boron magnet with the heavy rare earth slurry and drying the heavy rare earth slurry to form a heavy rare earth coating, wherein the heavy rare earth coating has a basic skeleton structure composed of the spherical high temperature resistant ceramic powder, and the heavy rare earth diffusion source powder is distributed in a three-dimensional network shape in gaps of the skeleton structure formed by the spherical high temperature resistant ceramic powder; and
(S3) subjecting the neodymium-iron-boron magnet coated with the heavy rare earth coating to high-temperature diffusion and aging treatment under vacuum or argon protection conditions.

Preferably, in step (S1), the heavy rare earth diffusion source powder is at least one of a pure terbium powder, a pure dysprosium powder, a dysprosium hydride powder and a terbium hydride powder, and the heavy rare earth diffusion source powder has an average particle size in a range of 2-10 μm.

Preferably, in step (S1), the organic adhesive is a resin adhesive or a rubber adhesive.

Preferably, the resin adhesive is polyvinyl chloride resin adhesive, and the rubber adhesive is isoamyl rubber adhesive or silicone rubber adhesive.

Preferably, in step (S1), the organic solvent is a ketone solvent, a benzene solvent or a lipid solvent.

Preferably, the ketone solvent is acetone, the benzene solvent is ethylbenzene, and the lipid solvent is butyl ester.

Preferably, in step (S1), the spherical high temperature resistant ceramic powder is at least one of a spherical alumina ceramic powder, a spherical zirconia ceramic powder and a spherical boron nitride ceramic powder; and the spherical high temperature resistant ceramic powder has a particle size in a range of 10-100 μm.

Preferably, in step (S1), the total weight of the heavy rare earth diffusion source powder and the spherical high temperature resistant ceramic powder is 40%-80% of the weight of the heavy rare earth slurry, the weight of the organic adhesive is 5%-10% of the weight of the heavy rare earth slurry, and the organic solvent is a remaining part.

Preferably, in step (S2), the heavy rare earth slurry is coated by screen printing or spraying.

Preferably, in step (S2), the weight of the heavy rare earth diffusion source powder in the heavy rare earth coating coated on the surface of the neodymium-iron-boron magnet is 0.3%-1.5% of the weight of the neodymium-iron-boron magnet.

Preferably, in step (S3), the high-temperature diffusion is performed at a temperature of 850-950° C. for 3-48 h; and the aging treatment is performed at a temperature of 450-650° C. for 3-10 h.

A magnet having high coercivity can be obtained by the method. The magnet includes a neodymium-iron-boron magnet and a heavy rare earth coating coated on a surface of the neodymium-iron-boron magnet, wherein the heavy rare earth coating includes a basic skeleton structure composed of a spherical high temperature resistant ceramic powder and a heavy rare earth diffusion source powder filled in the skeleton structure.

The method for improving the coercivity of a neodymium-iron-boron magnet and the magnet of the present disclosure at least have the following technical effects.
(1) A certain proportion and size of a spherical high temperature resistant ceramic powder is added into a heavy rare earth slurry and then coated and dried to form a heavy rare earth coating with a special structure. The special structure includes a basic skeleton structure composed of the spherical high temperature resistant ceramic powder and a heavy rare earth diffusion source distributed in a continuous three-dimensional network shape in gaps of the skeleton structure. By means of the basic skeleton structure formed by the spherical high temperature resistant ceramic powder in the heavy rare earth coating, on the one hand, the overall hardness and strength of a film layer are improved, and the wear resistance and scratch resistance of the film layer are enhanced; and on the other hand, shrinkage of the heavy rare earth film layer in diffusion and heating processes is prevented, so that heavy rare earth elements are distributed more uniformly in the diffusion process.
(2) The heavy rare earth diffusion source in the heavy rare earth coating is distributed in a continuous three-dimensional network shape in gaps of a skeleton formed by the spherical high temperature resistant ceramic powder, and the heavy rare earth diffusion source in the heavy rare earth coating diffuses continuously and stably in the neodymium-iron-boron magnet along gaps of the ceramic powder in the high-temperature diffusion process, so that excessive supply of the heavy rare earth diffusion source in a short term is avoided, the diffusion property and the diffusion uniformity are improved, and waste of the heavy rare earth elements is reduced. In addition, the heavy rare earth components in the heavy rare earth film layer are divided by the spherical ceramic powder to form a uniform and continuous network-shaped distribution, so that the diffusion of oxygen in the air from the outer surface of the coating to the inside of the coating is slowed down, and the oxidation resistance of the heavy rare earth coating is improved.
(3) In the coating process, due to the addition of the spherical ceramic powder, the fluidity and suspensibility of the slurry are improved, and the coating precision and the coating stability are improved. In addition, due to the increase of the ceramic powder, degassing channels in the heavy rare earth elements are improved, which are conductive to volatilization of an organic solvent and the like in the heavy rare earth slurry, and the production stability is improved.

### BRIEF DESCRIPTION OF THE DRAWINGS

FIG. 1 is a schematic diagram of a neodymium-iron-boron magnet coated with a heavy rare earth coating on a surface; and

FIG. 2 is a schematic diagram of a neodymium-iron-boron magnet cut in a diffusion direction.

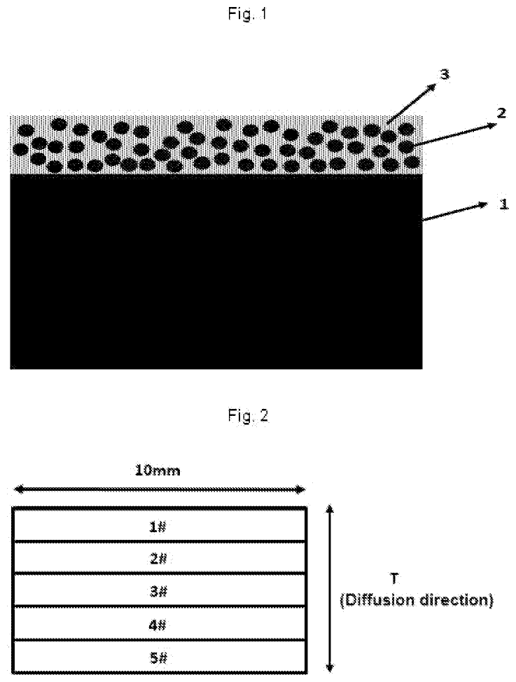

In FIG. 1, 1 refers to a neodymium-iron-boron magnet matrix; 2 refers to a spherical high temperature resistant ceramic powder; and 3 refers to a heavy rare earth diffusion source.

In FIG. 2, 1 # and 5 # refer to samples on outermost layers in the diffusion direction, and 3# refers to a sample at a central position in the diffusion direction.

### DETAILED DESCRIPTION OF THE EMBODIMENTS

Principles and features of the present disclosure are described in combination with FIG. 1 to FIG. 2 below. Examples provided are only used to explain the present disclosure and are not intended to limit the scope of the present disclosure.

### Example 1

(S1) A total of 4 raw materials, including a pure Tb powder with a particle size of 2 μm as a heavy rare earth diffusion source, Isoamyl rubber adhesive, acetone solvent and a spherical alumina ceramic powder with a particle size of 10 μm were used as raw materials of a heavy rare earth slurry. First, the pure Tb powder was mixed with the spherical alumina powder, wherein the weight of the spherical alumina ceramic powder was 10% of the weight of the pure Tb powder. Then, the mixed powder was used as a diffusion source intermediate, and the diffusion source intermediate, the rubber adhesive and the ketone organic solvent were mixed in weight proportions of 40%, 5% and 55%, respectively, and stirred evenly to prepare the heavy rare earth slurry.
(S2) The heavy rare earth slurry was coated on two surfaces (10*10 mm) of a neodymium-iron-boron matrix with a size of 10*10*5 mm by screen printing and dried to form a heavy rare earth coating with a special structure, wherein the weight ratio of heavy rare earth elements in the coating to the neodymium-iron-boron matrix was controlled to 0.8%, and the neodymium-iron-boron matrix was obtained by performing processes such as melting, pulverizing, molding, sintering and aging to obtain an N48H brand blank and then performing machining and had a size of 10*10*5 mm.
(S3) The neodymium-iron-boron magnet coated with the heavy rare earth coating was subjected to diffusion and aging under vacuum conditions, wherein the diffusion and aging processes were performed at a temperature of 850° C. for 48 h and at a temperature of 500° C. for 5 h, respectively. Then, overall magnetic properties of a product obtained after the diffusion was completed were tested.

The product obtained after the diffusion was completed was evenly cut into 5 pieces in a diffusion direction, and magnetic properties of magnets at different positions in the diffusion direction after the diffusion were tested.

In order to fully illustrate technical advantages of the patent scheme compared with a traditional coating and diffusion scheme, Comparative Example 1 was set below.

### Comparative Example 1

(S1) A total of 3 raw materials, including a pure Tb powder with a particle size of 2 μm as a heavy rare earth diffusion source, Isoamyl rubber adhesive and acetone solvent were used as raw materials of an heavy rare earth slurry. The pure Tb powder diffusion source, the rubber adhesive and the ketone organic solvent were mixed in weight proportions of 40%, 5% and 55%, respectively, and stirred evenly to prepare the heavy rare earth slurry.
(S2) The heavy rare earth slurry was coated on two surfaces (10*10 mm) of a neodymium-iron-boron matrix with a size of 101 O*5 mm by screen printing and dried to form a heavy rare earth coating, wherein the weight ratio of heavy rare earth elements in the coating to the neodymium-iron-boron matrix was controlled to 0.8%, and the neodymium-iron-boron matrix was obtained by performing processes such as melting, pulverizing, molding, sintering and aging to obtain an N48H brand blank and then performing machining and had a size of 10*10*5 mm.
(S3) The neodymium-iron-boron magnet coated with the heavy rare earth coating was subjected to diffusion and aging under vacuum conditions, wherein the diffusion and aging processes were performed at a temperature of 850° C. for 48 h and at a temperature of 500° C. for 5 h, respectively. Then, overall magnetic properties of a product obtained after the diffusion was completed were tested.

The product obtained after the diffusion was completed was evenly cut into 5 pieces in a diffusion direction, and magnetic properties of magnets at different positions in the diffusion direction after the diffusion were tested.

In order to compare the scratch resistance of heavy rare earth coatings in examples and comparative examples, a mutual friction experiment was carried out by enabling a sample coated with a heavy rare earth coating in Example 1 to get in contact with a coating surface of a sample coated with a heavy rare earth coating with a special structure in Comparative Example 1, proportions of exposed areas of matrices in total coating areas were calculated by statistics after heavy rare earth film layers on the surfaces of the samples in Example 1 and Comparative Example 1 were scratched, and statistical data were recorded in Table 1 and named as a scratch ratio.

In order to compare the shrinkage resistance of heavy rare earth coatings in examples and comparative examples in a high-temperature diffusion process, 100 pieces of diffusion samples in Example 1 and Comparative Example 1 were separately taken, proportions of samples having a shrinkage phenomenon of heavy rare earth film layers after diffusion in total statistical numbers were calculated by statistics, and statistical data were recorded in Table 1 and named as a shrinkage ratio.

Properties of a neodymium-iron-boron magnet before diffusion, overall properties of a neodymium-iron-boron magnet obtained after the diffusion was completed in Example 1 and overall properties of a neodymium-iron-boron magnet obtained after the diffusion was completed in Comparative Example 1 were compared, as shown in Table 1 below.

TABLE 1
Comparison of properties of magnets obtained
in Example 1 and Comparative Example 1

| Sample | | Shrinkage | | | |
|---|---|---|---|---|---|
| name | Scratch ratio | ratio | Br(KGS) | Hcj(KOe) | Hk/Hcj |
| N48H matrix | / | / | 13.8 | 17.10 | 0.982 |
| Example 1 | 0% | 0% | 13.62 | 27.50 | 0.975 |
| Comparative | 20% | 7% | 13.60 | 26.90 | 0.968 |
| Example 1 | | | | | |

From Table 1, it can be seen that the sample coated with a heavy rare earth coating with a special structure in Example 1 is not scratched in the mutual friction experiment with the sample coated with a heavy rare earth coating in Comparative Example 1, while the sample in Comparative Example 1 is scratched in a proportion of 20%, indicating that the heavy rare earth coating in Example 1 has higher scratch resistance. In addition, the heavy rare earth coating on the surface of the sample in Comparative Example 1 has a shrinkage phenomenon in a proportion of 7% in a high-temperature diffusion process, while the heavy rare earth coating on the surface of the sample in Example 1 has no shrinkage phenomenon in a high-temperature diffusion process, indicating that the heavy rare earth coating with a special structure prepared in Example 1 has higher shrinkage resistance than the heavy rare earth coating prepared in Comparative Example 1.

From Table 1, it can be seen that under same weight gain conditions of heavy rare earth elements, the content of Br in the magnet after the diffusion in Example 1 is reduced by 0.18 KGs, the intrinsic coercivity (Hcj) is improved by 10.4 KOe, and the squareness is reduced by 0.007. The content of Br in the magnet after the diffusion in Comparative Example 1 is reduced by 0.2 KGs, the Hcj is improved by 9.8 KOe, and the squareness is reduced by 0.014. Through the above results, it can be seen that properties of the neodymium-iron-boron magnets can be improved by the diffusion schemes in Example 1 and Comparative Example 1. However, under same weight gain conditions of heavy rare earth elements, the scheme in Example 1 has the advantages that the remanence is less reduced, the coercivity is improved to a higher level, and the squareness is less reduced.

The neodymium-iron-boron magnet before diffusion, the neodymium-iron-boron magnet obtained after the diffusion was completed in Example 1 and the neodymium-iron-boron magnet obtained after the diffusion was completed in Comparative Example 1 were evenly cut into 5 pieces in the diffusion direction, respectively, and then magnetic properties of these magnets were tested. The magnets after the diffusion were compared in uniformity of properties, as shown in Table 2 below.

TABLE 2
Comparison of uniformity of properties of magnets
obtained in Example 1 and Comparative Example 1

| | Matrix before | | Comparative |
|---|---|---|---|
| | diffusion | Example 1 | Example 1 |
| Sample number | Hcj(KOe) | Hcj(KOe) | Hcj(KOe) |
| 1# | 17.10 | 28.00 | 28.00 |
| 2# | 17.11 | 26.50 | 26.20 |
| 3# | 17.10 | 25.80 | 25.10 |
| 4# | 17.12 | 26.60 | 26.11 |
| 5# | 17.11 | 27.90 | 27.80 |

From Table 2, it can be seen that under same weight gain conditions of heavy rare earth elements and diffusion process conditions, the difference of the coercivity between a sample at an outermost layer position and a sample at a central position of the magnet obtained after diffusion in the diffusion direction in Example 1 is 1.85 KOe, and the Hcj of the sample at a central position is 8.7 KOe higher than that of the matrix. The difference of the coercivity between a sample at an outermost layer position and a sample at a central position of the magnet obtained after diffusion in the diffusion direction in Comparative Example 1 is 2.3 KOe, and the Hcj of the sample at a central position is 8 KOe higher than that of the matrix. In addition, the property of the magnet at a central position after diffusion in Example 1 is 0.7 KOe higher than that of the magnet at a central position after diffusion in Comparative Example 1. Through the above comparison, it can be seen that the magnet in Example 1 has a higher diffusion depth and is diffused more uniformly.

### Example 2

(S1) A total of 4 raw materials, including a mixture of a dysprosium hydride powder with a particle size of 5 μm and a pure dysprosium powder at a ratio of 1:1 as a heavy rare earth diffusion source powder, Polyvinyl chloride resin adhesive, Butyl ester solvent and a spherical zirconia ceramic powder with a particle size of 35 μm were used as raw materials of a heavy rare earth slurry. First, the heavy rare earth diffusion source powder was mixed with the spherical zirconia powder, wherein the weight of the zirconia ceramic powder was 15% of the weight of the heavy rare earth diffusion source powder. Then, the mixed powder was used as a diffusion source intermediate, and the diffusion source intermediate, the resin adhesive and the ester organic solvent were mixed in proportions of 60%, 10% and 30%, respectively, and stirred evenly to prepare the heavy rare earth slurry.
(S2) The heavy rare earth slurry was coated on two surfaces (10*10 mm) of a neodymium-iron-boron matrix with a size of 10*10*3 mm by screen printing and dried to form a heavy rare earth coating with a special structure, wherein the weight ratio of heavy rare earth elements in the coating to the neodymium-iron-boron matrix was controlled to 0.3%, and the neodymium-iron-boron matrix was obtained by performing processes such as melting, pulverizing, molding, sintering and aging to obtain an N55H brand blank and then performing machining and had a size of 10*10*3 mm.
(S3) The neodymium-iron-boron magnet coated with the heavy rare earth coating was subjected to diffusion and aging under the protection of an argon atmosphere, wherein the diffusion and aging processes were performed at a temperature of 900° C. for 3 h and at a temperature of 450° C. for 3 h, respectively. Then, overall magnetic properties of a product obtained after the diffusion was completed were tested.

The product obtained after the diffusion was completed was evenly cut into 3 pieces in a diffusion direction, and magnetic properties of magnets at different positions in the diffusion direction after the diffusion were tested.

In order to fully illustrate technical advantages of the patent scheme compared with a traditional coating and diffusion scheme, Comparative Example 2 was set below.
(S1) A total of 3 raw materials, including a mixture of a dysprosium hydride powder with a particle size of 5 μm and a pure dysprosium powder at a ratio of 1:1 as a heavy rare earth diffusion source powder, Polyvinyl chloride resin adhesive and Butyl ester solvent were used as raw materials of an heavy rare earth slurry. The heavy rare earth diffusion source powder, the resin adhesive and the ester organic solvent were mixed in proportions of 60%, 10% and 30%, respectively, and stirred evenly to prepare the heavy rare earth slurry.
(S2) The heavy rare earth slurry was coated on two surfaces (10*10 mm) of a neodymium-iron-boron matrix with a size of 10*10*3 mm by screen printing and dried to form a heavy rare earth coating with a special structure, wherein the weight ratio of heavy rare earth elements in the coating to the neodymium-iron-boron matrix was controlled to 0.3%, and the neodymium-iron-boron matrix was obtained by performing processes such as melting, pulverizing, molding, sintering and aging to obtain an N55H brand blank and then performing machining and had a size of 10*10*3 mm.
(S3) The neodymium-iron-boron magnet coated with the heavy rare earth coating was subjected to diffusion and aging under the protection of an argon atmosphere, wherein the diffusion and aging processes were performed at a temperature of 900° C. for 3 h and at a temperature of 450° C. for 3 h, respectively. Then, overall magnetic properties of a product obtained after the diffusion was completed were tested.

The product obtained after the diffusion was completed was evenly cut into 3 pieces in a diffusion direction, and magnetic properties of magnets at different positions in the diffusion direction after the diffusion were tested.

In order to compare the scratch resistance of heavy rare earth coatings in examples and comparative examples, a mutual friction experiment was carried out by enabling a sample coated with a heavy rare earth coating in Example 2 to get in contact with a coating surface of a sample coated with a heavy rare earth coating with a special structure in Comparative Example 2, proportions of exposed areas of matrices in total coating areas were calculated by statistics after heavy rare earth film layers on the surfaces of the samples in Example 2 and Comparative Example 2 were scratched, and statistical data were recorded in Table 3 and named as a scratch ratio.

In order to compare the shrinkage resistance of heavy rare earth coatings in examples and comparative examples in a high-temperature diffusion process, 100 pieces of diffusion samples in Example 2 and Comparative Example 2 were separately taken, proportions of samples having a shrinkage phenomenon of heavy rare earth film layers after diffusion in total statistical numbers were calculated by statistics, and statistical data were recorded in Table 3 and named as a shrinkage ratio.

Properties of a neodymium-iron-boron magnet before diffusion, overall properties of a neodymium-iron-boron magnet obtained after the diffusion was completed in Example 2 and overall properties of a neodymium-iron-boron magnet obtained after the diffusion was completed in Comparative Example 2 were compared, as shown in Table 3 below.

TABLE 3
Comparison of properties of magnets obtained
in Example 2 and Comparative Example 2

| Sample | | Shrinkage | | | |
|---|---|---|---|---|---|
| name | Scratch ratio | ratio | Br(KGS) | Hcj(KOe) | Hk/Hcj |
| N55H matrix | / | / | 14.61 | 15.52 | 0.989 |
| Example 2 | 0% | 0% | 14.52 | 19.33 | 0.981 |
| Comparative | 10% | 11% | 14.51 | 18.82 | 0.980 |
| Example 2 | | | | | |

From Table 3, it can be seen that the sample coated with a heavy rare earth coating with a special structure in Example 2 is not scratched in the mutual friction experiment with the sample coated with a heavy rare earth coating in Comparative Example 2, while the sample in Comparative Example 2 is scratched in a proportion of 10%, indicating that the heavy rare earth coating in Example 2 has higher scratch resistance. In addition, the heavy rare earth coating on the surface of the sample in Comparative Example 2 has a shrinkage phenomenon in a proportion of 11% in a high-temperature diffusion process, while the heavy rare earth coating on the surface of the sample in Example 2 has no shrinkage phenomenon in a high-temperature diffusion process, indicating that the heavy rare earth coating with a special structure prepared in Example 2 has higher shrinkage resistance than the heavy rare earth coating prepared in Comparative Example 2.

From Table 3, it can be seen that under same weight gain conditions of heavy rare earth elements, the content of Br in the magnet after the diffusion in Example 2 is reduced by 0.09 KGs, the Hcj is improved by 3.81 KOe, and the squareness is reduced by 0.008. The content of Br in the magnet after the diffusion in Comparative Example 2 is reduced by 0.1 KGs, the Hcj is improved by 3.3 KOe, and the squareness is reduced by 0.009. Through the above results, it can be seen that properties of the neodymium-iron-boron magnets can be improved by the diffusion schemes in Example 2 and Comparative Example 2. However, under same weight gain conditions of heavy rare earth elements, the scheme in Example 2 has the advantage that the coercivity is improved to a higher level.

The neodymium-iron-boron magnet before diffusion, the neodymium-iron-boron magnet obtained after the diffusion was completed in Example 2 and the neodymium-iron-boron magnet obtained after the diffusion was completed in Comparative Example 2 were evenly cut into 3 pieces in the diffusion direction, respectively, and then magnetic properties of these magnets were tested. The magnets after the diffusion were compared in uniformity of properties, as shown in Table 4 below.

TABLE 4
Comparison of uniformity of properties of magnets
obtained in Example 2 and Comparative Example 2

| | Matrix before | | Comparative |
|---|---|---|---|
| | diffusion | Example 2 | Example 2 |
| Sample number | Hcj(KOe) | Hcj(KOe) | Hcj(KOe) |
| 1# | 15.50 | 19.29 | 18.89 |
| 2# | 15.50 | 18.50 | 17.56 |
| 3# | 15.51 | 19.31 | 18.82 |

From Table 4, it can be seen that under same weight gain conditions of heavy rare earth elements and diffusion process conditions, the difference of the coercivity between a sample at an outermost layer position and a sample at a central position of the magnet obtained after diffusion in the diffusion direction in Example 2 is 0.8 KOe, and the Hcj of the sample at a central position is 3 KOe higher than that of the matrix. The difference of the coercivity between a sample at an outermost layer position and a sample at a central position of the magnet obtained after diffusion in the diffusion direction in Comparative Example 2 is 1.3 KOe, and the Hcj of the sample at a central position is 2.06 KOe higher than that of the matrix. In addition, the property of the magnet at a central position after diffusion in Example 2 is 0.94 KOe higher than that of the magnet at a central position after diffusion in Comparative Example 2. Through the above comparison, it can be seen that the magnet in Example 2 has a higher diffusion depth and is diffused more uniformly.

### Example 3

(S1) A total of 4 raw materials, including a terbium hydride powder with a particle size of 10 μm as a heavy rare earth diffusion source, Silicone rubber adhesive, ethylbenzene solvent and a spherical boron nitride ceramic powder with a particle size of 100 μm were used as raw materials of an heavy rare earth slurry. First, the terbium hydride powder was mixed with the spherical boron nitride powder, wherein the weight of the boron nitride ceramic powder was 10% of the weight of the terbium hydride powder. Then, the mixed powder was used as a diffusion source intermediate, and the diffusion source intermediate, the rubber adhesive and the benzene organic solvent were mixed in proportions of 80%, 6% and 14%, respectively, and stirred evenly to prepare the heavy rare earth slurry.
(S2) The heavy rare earth slurry was coated on two surfaces (10*10 mm) of a neodymium-iron-boron matrix with a size of 10*10*6 mm by spraying and dried to form a heavy rare earth coating with a special structure, wherein the weight ratio of heavy rare earth elements in the coating to the neodymium-iron-boron matrix was controlled to 1.0%, and the neodymium-iron-boron matrix was obtained by performing processes such as melting, pulverizing, molding, sintering and aging to obtain an N55H brand blank and then performing machining and had a size of 10*10*6 mm.
(S3) The neodymium-iron-boron magnet coated with the heavy rare earth coating was subjected to diffusion and aging under the protection of an argon atmosphere, wherein the diffusion and aging processes were performed at a temperature of 950° C. for 30 h and at a temperature of 600° C. for 10 h, respectively. Then, overall magnetic properties of a product obtained after the diffusion was completed were tested.

The product obtained after the diffusion was completed was evenly cut into 5 pieces in a diffusion direction, and magnetic properties of magnets at different positions in the diffusion direction after the diffusion were tested. In order to fully illustrate technical advantages of the patent scheme compared with a traditional coating and diffusion scheme, Comparative Example 3 was also set below.

### Comparative Example 3

(S1) A total of 3 substances, including a terbium hydride powder with a particle size of 10 μm as a heavy rare earth diffusion source, silicone rubber adhesive and ethylbenzene solvent were used as raw materials of an heavy rare earth slurry. The terbium hydride powder, the rubber adhesive and the benzene organic solvent were mixed in proportions of 80%, 6% and 14%, respectively, and stirred evenly to prepare the heavy rare earth slurry.
(S2) The heavy rare earth slurry was coated on two surfaces (10*10 mm) of a neodymium-iron-boron matrix with a size of 10*10*6 mm by spraying and dried to form a heavy rare earth coating with a special structure, wherein the weight ratio of heavy rare earth elements in the coating to the neodymium-iron-boron matrix was controlled to 1.0%, and the neodymium-iron-boron matrix was obtained by performing processes such as melting, pulverizing, molding, sintering and aging to obtain an N55H brand blank and then performing machining and had a size of 10*10*6 mm.
(S3) The neodymium-iron-boron magnet coated with the heavy rare earth coating was subjected to diffusion and aging under the protection of an argon atmosphere, wherein the diffusion and aging processes were performed at a temperature of 950° C. for 30 h and at a temperature of 600° C. for 10 h, respectively. Then, overall magnetic properties of a product obtained after the diffusion was completed were tested.

The product obtained after the diffusion was completed was evenly cut into 5 pieces in a diffusion direction, and magnetic properties of magnets at different positions in the diffusion direction after the diffusion were tested.

In order to compare the scratch resistance of heavy rare earth coatings in examples and comparative examples, a mutual friction experiment was carried out by enabling a sample coated with a heavy rare earth coating in Example 3 to get in contact with a coating surface of a sample coated with a heavy rare earth coating with a special structure in Comparative Example 3, proportions of exposed areas of matrices in total coating areas were calculated by statistics after heavy rare earth film layers on the surfaces of the samples in Example 3 and Comparative Example 3 were scratched, and statistical data were recorded in Table 5 and named as a scratch ratio.

In order to compare the shrinkage resistance of heavy rare earth coatings in examples and comparative examples in a high-temperature diffusion process, 100 pieces of diffusion samples in Example 3 and Comparative Example 3 were separately taken, proportions of samples having a shrinkage phenomenon of heavy rare earth film layers after diffusion in total statistical numbers were calculated by statistics, and statistical data were recorded in Table 5 and named as a shrinkage ratio.

Properties of a neodymium-iron-boron magnet before diffusion, overall properties of a neodymium-iron-boron magnet obtained after the diffusion was completed in Example 3 and overall properties of a neodymium-iron-boron magnet obtained after the diffusion was completed in Comparative Example 3 were compared, as shown in Table 5 below.

TABLE 5
Comparison of properties of magnets obtained
in Example 3 and Comparative Example 3

| Sample | | Shrinkage | | | |
|---|---|---|---|---|---|
| name | Scratch ratio | ratio | Br(KGS) | Hcj(KOe) | Hk/Hcj |
| N55H matrix | / | / | 14.61 | 15.52 | 0.989 |
| Example 3 | 0% | 0% | 14.38 | 26.8 | 0.980 |
| Comparative | 9% | 6% | 14.36 | 26 | 0.975 |
| Example 3 | | | | | |

From Table 5, it can be seen that the sample coated with a heavy rare earth coating with a special structure in Example 3 is not scratched in the mutual friction experiment with the sample coated with a heavy rare earth coating in Comparative Example 3, while the sample in Comparative Example 3 is scratched in a proportion of 9%, indicating that the heavy rare earth coating in Example 3 has higher scratch resistance. In addition, the heavy rare earth coating on the surface of the sample in Comparative Example 3 has a shrinkage phenomenon in a proportion of 6% in a high-temperature diffusion process, while the heavy rare earth coating on the surface of the sample in Example 3 has no shrinkage phenomenon in a high-temperature diffusion process, indicating that the heavy rare earth coating with a special structure prepared in Example 3 has higher shrinkage resistance than the heavy rare earth coating prepared in Comparative Example 3.

From Table 5, it can be seen that under same weight gain conditions of heavy rare earth elements, the content of Br in the magnet after the diffusion in Example 3 is reduced by 0.23 KGs, the Hcj is improved by 11.28 KOe, and the squareness is reduced by 0.009. The content of Br in the magnet after the diffusion in Comparative Example 3 is reduced by 0.25 KGs, the Hcj is improved by 10.48 KOe, and the squareness is reduced by 0.014. Through the above results, it can be seen that properties of the neodymium-iron-boron magnets can be improved by the diffusion schemes in Example 3 and Comparative Example 3. However, under same weight gain conditions of heavy rare earth elements, the scheme in Example 3 has the advantage that the coercivity is improved to a higher level.

The neodymium-iron-boron magnet before diffusion, the neodymium-iron-boron magnet obtained after the diffusion was completed in Example 3 and the neodymium-iron-boron magnet obtained after the diffusion was completed in Comparative Example 3 were evenly cut into 5 pieces in the diffusion direction, respectively, and then magnetic properties of these magnets were tested. The magnets after the diffusion were compared in uniformity of properties, as shown in Table 6 below.

TABLE 6
Comparison of uniformity of properties of magnets
obtained in Example 3 and Comparative Example 3

| | Matrix before | | Comparative |
|---|---|---|---|
| | diffusion | Example 3 | Example 3 |
| Sample number | Hcj(KOe) | Hcj(KOe) | Hcj(KOe) |
| 1# | 15.51 | 27.2 | 26.85 |
| 2# | 15.50 | 26.1 | 25.2 |
| 3# | 15.51 | 25.5 | 24.3 |
| 4# | 15.50 | 26.2 | 25.5 |
| 5# | 15.51 | 27.2 | 26.8 |

From Table 6, it can be seen that under same weight gain conditions of heavy rare earth elements and diffusion process conditions, the difference of the coercivity between a sample at an outermost layer position and a sample at a central position of the magnet obtained after diffusion in the diffusion direction in Example 3 is 1.7 KOe, and the Hcj of the sample at a central position is 10 KOe higher than that of the matrix. The difference of the coercivity between a sample at an outermost layer position and a sample at a central position of the magnet obtained after diffusion in the diffusion direction in Comparative Example 3 is 2.55 KOe, and the Hcj of the sample at a central position is 8.8 KOe higher than that of the matrix. In addition, the property of the magnet at a central position after diffusion in Example 3 is 1.2 KOe higher than that of the magnet at a central position after diffusion in Comparative Example 3. Through the above comparison, it can be seen that the magnet in Example 3 has a higher diffusion depth and is diffused more uniformly.

### Example 4

(S1) A total of 4 raw materials, including a terbium hydride powder with a particle size of 5 μm as a heavy rare earth diffusion source, Polyvinyl chloride resin adhesive, Butyl ester solvent and a spherical zirconia ceramic powder with a particle size of 50 μm were used as raw materials of a heavy rare earth slurry. First, the terbium hydride powder was mixed with the spherical zirconia powder, wherein the weight of the zirconia ceramic powder was 30% of the weight of the terbium hydride powder. Then, the mixed powder was used as a diffusion source intermediate, and the diffusion source intermediate, the resin adhesive and the ester organic solvent were mixed in proportions of 60%, 8% and 32%, respectively, and stirred evenly to prepare the heavy rare earth slurry.
(S2) The heavy rare earth slurry was coated on two surfaces (10*10 mm) of a neodymium-iron-boron matrix with a size of 10*10*8 mm by spraying and dried to form a heavy rare earth coating with a special structure, wherein the weight ratio of heavy rare earth elements in the coating to the neodymium-iron-boron matrix was controlled to 1.5%, and the neodymium-iron-boron matrix was obtained by performing processes such as melting, pulverizing, molding, sintering and aging to obtain an N42H brand blank and then performing machining and had a size of 10*10*8 mm.
(S3) The neodymium-iron-boron magnet coated with the heavy rare earth coating was subjected to diffusion and aging under vacuum conditions, wherein the diffusion and aging processes were performed at a temperature of 900° C. for 40 h and at a temperature of 650° C. for 8 h, respectively. Then, overall magnetic properties of a product obtained after the diffusion was completed were tested.

The product obtained after the diffusion was completed was evenly cut into 5 pieces in a diffusion direction, and magnetic properties of magnets at different positions in the diffusion direction after the diffusion were tested. In order to fully illustrate technical advantages of the patent scheme compared with a traditional coating and diffusion scheme, Comparative Example 4 was set below.

### Comparative Example 4

(S1) A total of 3 substances, including a terbium hydride powder with a particle size of 5 μm as a heavy rare earth diffusion source, Polyvinyl chloride resin adhesive and Butyl ester solvent were used as raw materials of an heavy rare earth slurry. The terbium hydride powder, the resin adhesive and the ester organic solvent were mixed in proportions of 60%, 8% and 32%, respectively, and stirred evenly to prepare the heavy rare earth slurry.
(S2) The heavy rare earth slurry was coated on two surfaces (10*10 mm) of a neodymium-iron-boron matrix with a size of 10*10*8 mm by spraying and dried to form a heavy rare earth coating with a special structure, wherein the weight ratio of heavy rare earth elements in the coating to the neodymium-iron-boron matrix was controlled to 1.5%, and the neodymium-iron-boron matrix was obtained by performing processes such as melting, pulverizing, molding, sintering and aging to obtain an N42H brand blank and then performing machining and had a size of 10*10*8 mm.
(S3) The neodymium-iron-boron magnet coated with the heavy rare earth coating was subjected to diffusion and aging under vacuum conditions, wherein the diffusion and aging processes were performed at a temperature of 900° C. for 40 h and at a temperature of 650° C. for 8 h, respectively. Then, overall magnetic properties of a product obtained after the diffusion was completed were tested.

The product obtained after the diffusion was completed was evenly cut into 5 pieces in a diffusion direction, and magnetic properties of magnets at different positions in the diffusion direction after the diffusion were tested.

In order to compare the scratch resistance of heavy rare earth coatings in examples and comparative examples, a mutual friction experiment was carried out by enabling a sample coated with a heavy rare earth coating in Example 4 to get in contact with a coating surface of a sample coated with a heavy rare earth coating with a special structure in Comparative Example 4, proportions of exposed areas of matrices in total coating areas were calculated by statistics after heavy rare earth film layers on the surfaces of the samples in Example 4 and Comparative Example 4 were scratched, and statistical data were recorded in Table 7 and named as a scratch ratio.

In order to compare the shrinkage resistance of heavy rare earth coatings in examples and comparative examples in a high-temperature diffusion process, 100 pieces of diffusion samples in Example 4 and Comparative Example 4 were separately taken, proportions of samples having a shrinkage phenomenon of heavy rare earth film layers after diffusion in total statistical numbers were calculated by statistics, and statistical data were recorded in Table 7 and named as a shrinkage ratio.

Properties of a neodymium-iron-boron magnet before diffusion, overall properties of a neodymium-iron-boron magnet obtained after the diffusion was completed in Example 4 and overall properties of a neodymium-iron-boron magnet obtained after the diffusion was completed in Comparative Example 4 were compared, as shown in Table 7 below.

TABLE 7
Comparison of properties of magnets obtained
in Example 4 and Comparative Example 4

| Sample | | Shrinkage | | | |
|---|---|---|---|---|---|
| name | Scratch ratio | ratio | Br(KGS) | Hcj(KOe) | Hk/Hcj |
| N42H matrix | / | / | 13.20 | 18.05 | 0.981 |
| Example 4 | 0% | 0% | 12.92 | 30 | 0.972 |
| Comparative | 21% | 13% | 12.88 | 29.45 | 0.968 |
| Example 4 | | | | | |

From Table 7, it can be seen that the sample coated with a heavy rare earth coating with a special structure in Example 4 is not scratched in the mutual friction experiment with the sample coated with a heavy rare earth coating in Comparative Example 4, while the sample in Comparative Example 4 is scratched in a proportion of 21%, indicating that the heavy rare earth coating in Example 4 has higher scratch resistance. In addition, the heavy rare earth coating on the surface of the sample in Comparative Example 4 has a shrinkage phenomenon in a proportion of 13% in a high-temperature diffusion process, while the heavy rare earth coating on the surface of the sample in Example 4 has no shrinkage phenomenon in a high-temperature diffusion process, indicating that the heavy rare earth coating with a special structure prepared in Example 4 has higher shrinkage resistance than the heavy rare earth coating prepared in Comparative Example 4.

From Table 7, it can be seen that under same weight gain conditions of heavy rare earth elements, the content of Br in the magnet after the diffusion in Example 4 is reduced by 0.28 KGs, the Hcj is improved by 11.95 KOe, and the squareness is reduced by 0.009. The content of Br in the magnet after the diffusion in Comparative Example 4 is reduced by 0.32 KGs, the Hcj is improved by 11.4 KOe, and the squareness is reduced by 0.013. Through the above results, it can be seen that properties of the neodymium-iron-boron magnets can be improved by the diffusion schemes in Example 4 and Comparative Example 4. However, under same weight gain conditions of heavy rare earth elements, the scheme in Example 4 has the advantage that the coercivity is improved to a higher level.

The neodymium-iron-boron magnet before diffusion, the neodymium-iron-boron magnet obtained after the diffusion was completed in Example 4 and the neodymium-iron-boron magnet obtained after the diffusion was completed in Comparative Example 4 were evenly cut into 5 pieces in the diffusion direction, respectively, and then magnetic properties of these magnets were tested. The magnets after the diffusion were compared in uniformity of properties, as shown in Table 8 below.

TABLE 8
Comparison of uniformity of properties of magnets
obtained in Example 4 and Comparative Example 4

| | Matrix before | | Comparative |
|---|---|---|---|
| | diffusion | Example 1 | Example 1 |
| Sample number | Hcj(KOe) | Hcj(KOe) | Hcj(KOe) |
| 1# | 18.01 | 31.02 | 30.8 |
| 2# | 18.00 | 29.12 | 28.5 |
| 3# | 18.01 | 28.21 | 27.1 |
| 4# | 18.02 | 29.02 | 28.6 |
| 5# | 18.00 | 31.01 | 30.9 |

From Table 8, it can be seen that under same weight gain conditions of heavy rare earth elements and diffusion process conditions, the difference of the coercivity between a sample at an outermost layer position and a sample at a central position of the magnet obtained after diffusion in the diffusion direction in Example 4 is 2.81 KOe, and the Hcj of the sample at a central position is 10.02 KOe higher than that of the matrix. The difference of the coercivity between a sample at an outermost layer position and a sample at a central position of the magnet obtained after diffusion in the diffusion direction in Comparative Example 4 is 3.75 KOe, and the Hcj of the sample at a central position is 9.09 KOe higher than that of the matrix. In addition, the property of the magnet at a central position after diffusion in Example 4 is 1.11 KOe higher than that of the magnet at a central position after diffusion in Comparative Example 4. Through the above comparison, it can be seen that the magnet in Example 4 has a higher diffusion depth and is diffused more uniformly.

The descriptions above are only preferred embodiments of the present disclosure and are not intended to limit the present disclosure. Any modifications, equivalent substitutions, improvements and the like made within the spirit and principles of the present disclosure shall be included in the scope of protection of the present disclosure.

What claimed is:

1. A method for improving the coercivity of a neodymium-iron-boron magnet, comprising the following steps:
(S1) subjecting a heavy rare earth diffusion source powder, an organic adhesive, a spherical high temperature resistant ceramic powder and an organic solvent to mixing and stirring to prepare a heavy rare earth slurry, wherein the particle size of the spherical high temperature resistant ceramic powder is required to be 5-10 times of that of the diffusion source powder, and the weight of the spherical high temperature resistant ceramic powder is 10%-30% of that of the heavy rare earth diffusion source powder;
(S2) coating a surface of a neodymium-iron-boron magnet with the heavy rare earth slurry and drying the heavy rare earth slurry to form a heavy rare earth coating, wherein the heavy rare earth coating has a basic skeleton structure composed of the spherical high temperature resistant ceramic powder, and the heavy rare earth diffusion source powder is distributed in a three-dimensional network shape in gaps of the skeleton structure formed by the spherical high temperature resistant ceramic powder; and
(S3) subjecting the neodymium-iron-boron magnet coated with the heavy rare earth coating to high-temperature diffusion and aging treatment under vacuum or argon protection conditions.

2. The method for improving the coercivity of a neodymium-iron-boron magnet according to claim 1, wherein in step (S1), the heavy rare earth diffusion source powder is at least one of a pure terbium powder, a pure dysprosium powder, a dysprosium hydride powder and a terbium hydride powder, and the heavy rare earth diffusion source powder has an average particle size in a range of 2-10 μm.

3. The method for improving the coercivity of a neodymium-iron-boron magnet according to claim 1, wherein in step (S1), the organic adhesive is a resin adhesive or a rubber adhesive.

4. The method for improving the coercivity of a neodymium-iron-boron magnet according to claim 3, wherein the resin adhesive is polyvinyl chloride resin adhesive.

5. The method for improving the coercivity of a neodymium-iron-boron magnet according to claim 3, wherein the rubber adhesive is isoamyl rubber adhesive or silicone rubber adhesive.

6. The method for improving the coercivity of a neodymium-iron-boron magnet according to claim 1, wherein in step (S1), the organic solvent is a ketone solvent, a benzene solvent or a lipid solvent.

7. The method for improving the coercivity of a neodymium-iron-boron magnet according to claim 6, wherein the ketone solvent is acetone.

8. The method for improving the coercivity of a neodymium-iron-boron magnet according to claim 6, wherein the benzene solvent is ethylbenzene.

9. The method for improving the coercivity of a neodymium-iron-boron magnet according to claim 6, wherein the lipid solvent is butyl ester.

10. The method for improving the coercivity of a neodymium-iron-boron magnet according to claim 1, wherein in step (S1), the spherical high temperature resistant ceramic powder is at least one of a spherical alumina ceramic powder, a spherical zirconia ceramic powder and a spherical boron nitride ceramic powder.

11. The method for improving the coercivity of a neodymium-iron-boron magnet according to claim 10, wherein the spherical high temperature resistant ceramic powder has a particle size in a range of 10-100 μm.

12. The method for improving the coercivity of a neodymium-iron-boron magnet according to claim 1, wherein in step (S1), the total weight of the heavy rare earth diffusion source powder and the spherical high temperature resistant ceramic powder is 40%-80% of the weight of the heavy rare earth slurry, the weight of the organic adhesive is 5%-10% of the weight of the heavy rare earth slurry, and the organic solvent is a remaining part.

13. The method for improving the coercivity of a neodymium-iron-boron magnet according to claim 1, wherein in step (S2), the heavy rare earth slurry is coated by screen printing or spraying.

14. The method for improving the coercivity of a neodymium-iron-boron magnet according to claim 1, wherein in step (S2), the weight of the heavy rare earth diffusion source powder in the heavy rare earth coating coated on the surface of the neodymium-iron-boron magnet is 0.3%-1.5% of the weight of the neodymium-iron-boron magnet.

15. The method for improving the coercivity of a neodymium-iron-boron magnet according to claim 1, wherein in step (S3), the high-temperature diffusion is performed at a temperature of 850-950° C. for 3-48 h.

16. The method for improving the coercivity of a neodymium-iron-boron magnet according to claim 1, wherein in step (S3), the aging treatment is performed at a temperature of 450-650° C. for 3-10 h.

17. A magnet, comprising a neodymium-iron-boron magnet and a heavy rare earth coating coated on a surface of the neodymium-iron-boron magnet, wherein the heavy rare earth coating comprises a basic skeleton structure composed of a spherical high temperature resistant ceramic powder and a heavy rare earth diffusion source powder filled in the skeleton structure.
